(19) United States
(12) Patent Application Publication
(10) Pub. No.: US 2008/0023680 A1
(43) Pub. Date: Jan. 31, 2008

(54) NON-HALOGEN FLAME-RESISTANT THERMOPLASTIC ELASTOMER COMPOSITION, MANUFACTURING METHOD THEREOF, AND ELECTRIC WIRE OR CABLE IN WHICH ITS ELASTOMER COMPOSITION IS USED

(76) Inventors: Takashi Inoue, Yonezawa (JP); Keisuke Sugita, Hitachi (JP); Daisuke Abe, Hitachi (JP); Hitoshi Kimura, Hitachi (JP); Kiyoshi Watanabe, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/830,232

(22) Filed: Jul. 30, 2007

(30) Foreign Application Priority Data
Jul. 31, 2006 (JP) 2006-208362

(51) Int. Cl. C09K 21/14

(52) U.S. Cl. 252/609

(57) ABSTRACT

Non-halogen flame-resistant thermoplastic elastomer composition, manufacturing method, and an electric wire or cable in which non-halogen flame-resistant thermoplastic elastomer composition is used for an insulator or a sheath are provided. Non-halogen flame-resistant thermoplastic elastomer composition includes (A) 40 to 80 parts by weight of ethylene-vinyl acetate copolymer, in which the content of vinyl acetate is 30 wt % or more; (B) 60 to 20 parts by weight of crystalline polyolefin resin; and (C) 40 to 250 parts by weight of metalhydroxide for 100 parts by weight in total of (A) and (B). Further, ethylene-vinyl acetate copolymer is cross-linked with silane.

### BACKGROUND OF THE INVENTION

The present invention relates to non-halogen flame-resistant thermoplastic elastomer composition which excels in elastic behavior and flame resistance and has high mechanical strength, heat resistance, oil resistance, and recyclability at the same time, and especially to non-halogen flame-resistant thermoplastic elastomer composition obtained by cross-linking with silane while mixing ethylene vinyl acetate copolymer in which vinyl acetate content is 30 wt % or more, manufacturing method thereof, and an electric wire or cable in which its elastomer composition is used

The activity to the environmental protection is rising worldwide. in the field of electric wire coating material, the material which does not generate poisonous gas when burning, which can decrease environmental pollution when disposed, and which can recycle have rapidly prevailed.

Generally as such a material, there is a composition in which non-halogen flame retarder such as metalhydroxide is mixed to base polymers such as crystalline polyolefin based resins, thermoplastic elastomers. Especially, the thermoplastic elastomer with modulus of elasticity in the middle of rubber and resin and the composition of the flame retarder are often used for applications in which a soft material is needed.

By now, various thermoplastic elastomers have been developed. For instance, the composition created by dispersing cross-linked rubber components in the matrix of polyolefin resins which are flow components by using the technology of dynamic crosslink which bridges specific components while mixing is known well. In such a dynamic crosslink technique, the selection of the rubber cross-linking agent becomes important. An ideal cross-linking agent is the one with the reaction velocity of extent where the cross-linking reaction is completed while mixing, which can selectively cross-link the rubber components.

As a result, because the cross-linked rubber particles are created while mixing even if a large amount of rubber components is included, and distributing the rubber components to a thermoplastic resin become possible. For instance, the one generally used as such cross-linking agent includes sulfur, organic peroxide, etc.

The above-mentioned technique is disclosed in the following Japanese official gazettes.
(1) Japanese Patent Application Laid-open No. 2000-212291
(2) Japanese Patent Publication No. 07-010941
(3) Japanese Patent Application Laid-open No. 2000-327864
(4) Japanese Patent Publication No. 62-9135
(5) Japanese Patent Application Laid-open No. 04-335055
(6) Japanese Patent Application Laid-open No. 04-339829
(7) Japanese Patent Application Laid-open No. 04-149238
(8) Japanese Patent Application Laid-open No. 05-032850

However, in the cross-linking by sulfur, there are problems that it is difficult to set the color hue of the molding freely because of coloring, and that the nasty smell is issued in the generation of sulfidization-system gases. Moreover, it is necessary to choose the resin to which the crosslink does not happen easily because polyolefin based resins which is the flow component are cross-linked simultaneously in the crosslink by organic superoxide. Therefore, it is possible to select nothing besides polypropylene which is substantially in a hard class. As a result, there is a limit to bring the softness of the composition close to a halogen system material such as polyvinyl chloride.

### BRIEF SUMMARY OF THE INVENTION

Therefore, An object of the present invention is to provide non-halogen flame-resistant thermoplastic elastomer composition, which has no problem of the nasty smell and the coloring, can select freely the polyolefin based resin, and has the same softness as halogen system material, manufacturing method thereof, and electric wire or cable in which its elastomer composition is used,

To achieve the above-mentioned object, in one aspect of the present invention, non-halogen flame-resistant thermoplastic elastomer composition comprises: (A) 40 to 80 parts by weight of ethylene-vinyl acetate copolymer, in which the content of vinyl acetate is 30 wt % or more; (B) 60 to 20 parts by weight of crystalline polyolefin resin; and (C) 40 to 250 parts by weight of metalhydroxide for 100 parts by weight in total of said (A) and (B); wherein said ethylene-vinyl acetate copolymer is cross-linked with silane.

Preferably, in non-halogen flame-resistant thermoplastic elastomer composition, wherein the phase of said ethylene vinyl acetate copolymer defined as said (A) is dispersed in the phase of crystalline polyolefin resin defined as (B).

Preferably, in non-halogen flame-resistant thermoplastic elastomer composition, wherein said crystalline polyolefin resin defined as said (B) is at least one selected from polypropylene, high density polyethylene, linear low density polyethylene, very low density polyethylene, ethylene-butene-1 copolymer, ethylene-hexene-1 copolymer, ethylene-octene-1 copolymer, ethylene vinyl acetate copolymer, ethylene-ethylacrylate copolymer.

Preferably, in the non-halogen flame-resistant thermoplastic elastomer composition, metalhydroxide defined as said (C) is magnesium hydroxide, whose surface is treated with the silane based coupling agent.

Preferably, in the non-halogen flame-resistant thermoplastic elastomer composition, unsaturated carboxylic acid or derivative thereof is copolymerized to a part of ethylene-vinyl acetate copolymer defined as (A) or a part of crystalline polyolefin resin defined as said (B).

In another aspect of the present invention, a method of manufacturing non-halogen flame-resistant thermoplastic elastomer composition mentioned above is provided. Wherein said ethylene vinyl acetate copolymer cross-linked with silane is created by mixing ethylene vinyl acetate copolymer in which silicon analogues are polymerized by grafting, metalhydroxide and silanol condensation catalyst.

Preferably, in the manufacturing method, metalhydroxide and crystalline polyolefin based resin are added after graft-copolimerizing silicon analogues to ethylene vinyl acetate copolymer.

In a further aspect of the present invention, an electric wire or cable is provided. Wherein non-halogen flame-resistant thermoplastic elastomer composition mentioned above is used for an insulator or a sheath.

An excellent non-halogen flame-resistant thermoplastic elastomer composition in elastic behavior and flame resistance can be offered according to the present invention. Especially, the composition of the present invention can be melt by heat after cross-linking, thus can be molded, because ethylene vinyl acetate copolymer cross-linked with silane is dispersed into crystalline polyolefin based resin. Accordingly, it has the recyclability. Moreover, this composition possesses at the same time high mechanical strength, heat resistance, and oil resistance, and is suitable as material of the coatings of electric wires and cables such as power supply codes, cabtire cables, etc.

### BRIEF DESCRIPTION OF THE SEVERAL VIEWS OF THE DRAWINGS

FIG. 1 is a detailed sectional view of the electric wire to which the present invention is applied.

FIG. 2 is a detailed sectional view of the cable to which the present invention is applied.

FIG. 3 is a detailed sectional view of the cable to which the present invention is applied.

FIG. 4 is a table showing characteristics of embodiments of the present invention and comparative examples.

### DETAILED DESCRIPTION OF THE PREFERRED EMBODIMENTS

One preferable embodiment of the present invention will be explained in detail with reference to attached drawings.

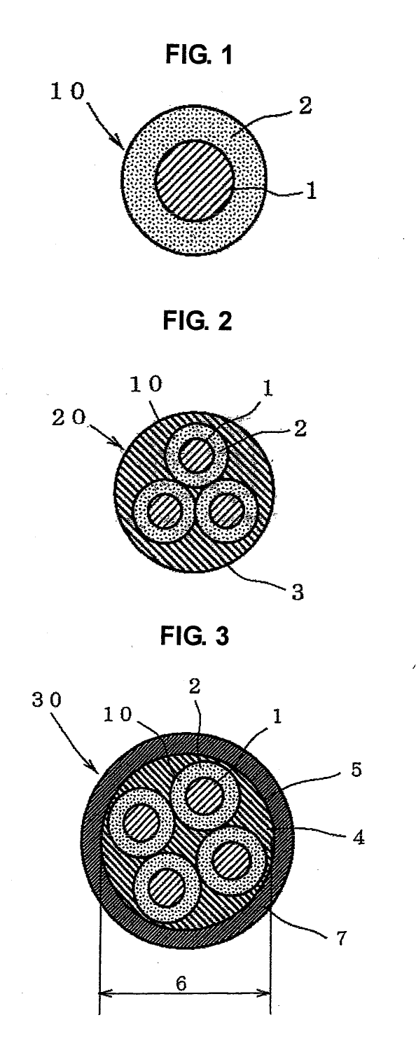

First of all, the electric wire and the cable to which the non-halogen flame-resistant thermoplastic elastomer composition of the present invention is applied are explained by referring FIG. 1 to FIG. 3. FIG. 1 shows electric wire 10 in which insulator 2 which consists of the non-halogen flame-resistant thermoplastic elastomer composition covers copper conductor 1.

FIG. 2 shows cable 20 in which three electric wires 10 shown in FIG. 1 are intertwined with one another, and sheath 3 which consists of the non-halogen flame-resistant thermoplastic elastomer composition covers their outer surface.

FIG. 3 shows cable 30, in which core 6 is formed by intertwining a plurality of wires (4 wires in FIG. 3) and winding a covering tape around them, and sheath 7 which consists of the non-halogen flame-resistant thermoplastic elastomer composition covers an outer surface of core 6.

Insulator 2, sheathes 3 and 7 shown in FIG. 1-FIG. 3, which are made of non-halogen flame-resistant thermoplastic elastomer composition are covered by extrusion molding.

When a cross-linking method was examined to achieve the above-mentioned object, it was found to be effective means to use crosslink by silane in the present invention.

It is required to cross-link by contacting moisture in the presence of silanol condensation catalyst after molding, because crosslink reaction is slower than the system which uses sulfur or organic peroxide in the past. Therefore, it has been thought that thermoplastic composition which disperses silane cross-linking rubber phase is not obtained, and the application of the silane crosslink is difficult for the technique of a dynamic crosslink.

The inventors found that metalhydroxides and silanol condensation catalysts make the remarkable promotion of the cross-linking reaction of ethylene vinyl acetate copolymer in which silicon analogues are graft-copolymerized when the ethylene vinyl acetate copolymer in which the content of vinyl acetate is 30 wt % or more is used as rubber component.

As a result, Non-halogen flame-resistant thermoplastic elastomer composition comprising: 40 to 80 parts by weight of ethylene-vinyl acetate copolymer, in which the content of vinyl acetate is 30 wt % or more; (B) 60 to 20 parts by weight of crystalline polyolefin resin; and (C) 40 to 250 parts by weight of metalhydroxide for 100 parts by weight in total of (A) and (B); ethylene-vinyl acetate copolymer being cross-linked with silane was able to be obtained.

The inventors found that this composition excels in elastic behavior and flame resistance and at the same time it has high mechanical strength, heat resistance, and oil resistance, and has the recyclability because the phase of said ethylene vinyl acetate copolymer defined as (A) is dispersed in the phase of crystalline polyolefin resin defined as (B).

The content of vinyl acetate in ethylene vinyl acetate copolymer defined as said (A) is 30 wt % or more in the present invention. When the vinyl acetate content is less than 30 wt %, the same elastic behavior as halogen is not obtained because of the hardness of the composition. There is especially no limitation in molecular weight and the melt viscosity, etc. and the arbitrary one can be used.

Silicon analogues are copolymerized to ethylene vinyl acetate copolymer defined as (A) to effect the silane crosslink.

It is required for silicon analogues to have both of alkoxy group which cross-links by silanol condensation and group which can react with polymer. Concretely, they include, but are not limited to vinylsilane compounds such as vinyl trimethoxysilane, vinyl triethoxysilane, and vinyl-tris(β-methoxyethoxy) silane; aminosilane compounds such as γ-aminopropyltrimethoxysilane, γ-aminopropyltriethoxysilane, N-β-(aminoethyl)γ-aminopropyltrimethoxysilane, β-(aminoethyl)γ-aminopropylmethyldimethoxysilane, and N-phenyl-γ-aminopropyltrimethoxysilanes; epoxysilane compounds such as β-(3,4 epoxycyclohexyl)ethyltrimethoxysilane, γ-glycidoxypropyltrimethoxysilane, and γ-glycidoxypropylmethyldimethoxysilane; acrylsilane compounds such as γ-methacryloxypropyltrimethoxysilane, polysulfidesilicon compound such as bis-(3-(triethoxysilylpropyl)disulfide bis-(3-(triethoxysilylpropyl)tetrasulfide mercaptosilane compounds such as 3-mercaptopropyltrimethoxysilane, 3-mercaptopropyltriethoxysilanes.

To graft-copolymerize silicon analogue, it is possible to use an already-known general technique. Namely, a method of blending a specified amount of silicon analogue and free radical generation agent to ethylene vinyl acetate copolymer as a base, and subsequently mixing them while melting at the temperature of 80-200° C. can be applied.

Organic superoxide such as dicumyl peroxide can be chiefly used as free radical generation agent.

As for an additional amount of silicon analogues, 0.5-10.0 parts by weight for 100 parts by weight of ethylene vinyl acetate copolymer is suitable to obtain excellent physical properties, but it is not limited to that amount. An effect of crosslink is not achieved sufficiently when it is fewer than 0.5 parts by weight, and the strength and heat resistance of the composition are inferior. The processing decreases remarkably when it exceeds 10.0 parts by weight.

Moreover, the best amount of organic peroxide which is free radical generation agent is 0.001-3.0 parts by weight for 100 parts by weight of ethylene vinyl acetate copolymer. silicon analogues is not graft-polymerized sufficiently when it is fewer than 0.001 parts by weight, and an effect of crosslink is not obtained enough. Scorching of ethylene vinyl acetate copolymer occurs easily when it exceeds 3.0 parts by weight.

Crystalline polyolefin resin defined as (A) may be the already-known one. Especially, it is preferable to blend at least one selected from polypropylene, high density polyethylene, linear low density polyethylene, super-low density polyethylene, ethylene-butene-1 copolymer, ethylene-hexene-1 copolymer, ethylene-octane-1 copolymer, ethylene vinyl acetate copolymer, and ethylene ethylacrylate copolymer.

the above-mentioned polypropylene includes homopolymer and block copolymer or random copolymer in which α-olefin, for example, ethylene is copolymerized and polypropylene in which rubber component is introduced at the polymerization stage such as EPR (ethylene propylene rubber). The one whose the content of vinyl acetate that has crystalline is fewer than 30 wt % can be used as the above-mentioned ethylene vinyl acetate copolymer. Moreover, the low density polyethylene, poly butene, poly-4-methylic-pentene, ethylene-butene-hexene terpolymer, ethylene methylicmethacrylate copolymer, ethylene methylacrylate copolymer, and ethylene glycidylmethacrylate copolymer, etc. are included.

In the present invention, The mixing ratio of ethylene vinyl acetate copolymer defined as (A) and crystalline polyolefin resin defined as (B) is 40 to 80 parts by weight of (A) and 60 to 20 parts by weight of (B) for 100 part by weight in total of both. When the component of (A) exceeds 80 parts by weight, the characteristic of extrusion molding deteriorates remarkably. Moreover, when it is fewer than 40 parts by weight, the excellent, elastic behavior is not obtained.

The metalhydroxide defined as (C) in the present invention provides flame resistance to the composition. At the same time, it promotes the crosslink of ethylene vinyl acetate copolymer in which silicon analogues are graft-copolymerized along with the silanol condensation catalyst, and enables cross-linking while mixing.

The mechanism which promotes cross-linking is uncertain yet. We guess that the moisture of the metalhydroxide promotes the hydrolysis of alkoxy group, so that silanol condensation catalyst promotes the dehydration condensation of the silanol group.

Such metalhydroxide includes magnesium hydroxide, aluminium hydroxide, calcium hydroxide, etc. Especially, magnesium hydroxide with the highest flame-resistant effect is suitable. Further, It is preferable that the surface of metalhydroxide is treated from a viewpoint of dispersibility.

As coupling agent”, silane-system coupling agent, titanate-system coupling agent, fatty acid or fatty acid metal salt, etc. can be used. Especially, the silane-system coupling agent is preferable in the point to improve adhesion between resin and metalhydroxide.

A silane system coupling agent which can be used includes, but are not limited to vinylsilane compounds such as vinyl trimethoxysilane, vinyl triethoxysilane, and vinyl-tris(β-methoxyethoxy)silane; aminosilane compounds such as γ-aminopropyltrimethoxysilane, γ-aminopropyltriethoxysilane, N-β-(aminoethyl)γ-aminopropyltrimethoxysilane, β-(aminoethyl)γ-aminopropylmethyldimethoxysilane, and N-phenyl-γ-aminopropyltrimethoxysilanes; epoxysilane compounds such as β-(3,4 epoxycyclohexyl)ethyltrimethoxysilane, γ-glycidoxypropyltrimethoxysilane, and γ-glycidoxypropylmethyldimethoxysilane; acrylsilane compounds such as γ-methacryloxypropyltrimethoxysilane, polysulfidesilicon compound such as bis-(3-(triethoxysilylpropyl)disulfide bis-(3-(triethoxysilylpropyl)tetrasulfide mercaptosilane compounds such as 3-mercaptopropyltrimethoxysilane, 3-mercaptopropyltriethoxysilanes.

It is possible to use already-known one of a wet method, a dry method, and a direct mixture method, etc. as a method of processing these surface treatment agents to the metalhydroxide.

Although the treatment amount is not limited to the specified value, It is preferable that it is within a range of 0.1 wt % and 5 wt % for metalhydroxide. The strength of resin composition deteriorates when the treatment amount is less than 0.1 wt %. Moreover, the processing worsens when it is more than 5 wt %.

In addition, it is preferable that the mean particle size of metalhydroxide is less than 4 μm from a view point of a mechanical characteristic, dispersibility, and flame resistance.

The additional amount of metalhydroxide defined as (C) is 40 to 250 parts by weight of metalhydroxide for 100 parts by weight in total of (A) and (B). An excellent effect of the flame resisting is not obtained when it is fewer than 40 parts by weight. Moreover, the elastic behavior and the mechanical strength deteriorate remarkably when it exceeds 250 parts by weight.

In the present invention, unsaturated carboxylic acid or derivative thereof can be copolymerized to a part of ethylene-vinyl acetate copolymer defined as (A) or a part of crystalline polyolefin resin defined as (B). That is, crystalline polyolefin resin or ethylene vinyl acetate copolymer in which metalhydroxide defined as (C) and unsaturated carboxylic acid or its derivative can be used. As a result, the mechanical strength of the composition is improved because a reaction is occurred between metalhydroxide defined as (C) and unsaturated carboxylic acid or its derivative to improve adhesion. The above-mentioned one can be used as it is for ethylene vinyl acetate copolymer or crystalline polyolefine here.

Maleic anhydride is suitable though unsaturated carboxylic acid or its derivative is not especially limited. Moreover, 0.5 to 10 parts by weight-part are preferable though the replaced amount is arbitrary. An effect of the strength improvement is not achieved when it is fewer than 0.5 parts by weight. Moreover, the processing deteriorates remarkably when it exceeds 10 parts by weight.

Moreover, silanol condensation catalyst which can be used in the present invention includes dibutyltin dilaurate, dibutyltin diacetate, dibutyltin dioctoate, stannous acetate, stannous octoate, zinc caprylate, lead naphthenate, and cobalt naphthenate, etc, and the additional amount is set to 0.001-0.1 parts by weight per 100 parts by weight of rubber though it depends on the kind of the catalyst.

The addition method includes a method of using masterbatch in which the additives are mixed with ethylene vinyl acetate copolymer or crystalline polyolefin resin beforehand besides a method of adding as it is.

Additives such as process oil, processing aid, flame resisting auxiliary agent, cross-linking agent, cross-linking auxiliary agent, antioxidant, lubricant, inorganic filler, phase-melting agent, stabilizing agent, carbon blacks, and coloring agent can be added if necessary besides the above-mentioned.

General-purpose one such as a kneader, a Banbury mixer, a roll, and a twin screw extruder, etc. can be used though there is no limitation in an apparatus which manufactures the composition of the present invention. The manufacturing method comprises the following two processes.
(1) A process where silicon analogues is graft-copolymerized to ethylene vinyl acetate copolymer.
(2) A process where ethylene vinyl acetate copolymer is cross-linked with silane while mixing compounding ingredient such as ethylene vinyl acetate copolymer, crystalline polyolefin resin, metalhydroxides, and silanol condensation catalysts. The manufacturing method is not limited to a method of doing separately these processes or a method of doing both processes in one extrusion by using a twin screw extruder etc.

Moreover, the order when three components (ethylene vinyl acetate copolymer, crystalline polyolefin resin, and metalhydroxide) are mixed is arbitrary.

### That is,

(1) A method of mixing ethylene vinyl acetate copolymer with metalhydroxide previously, and subsequently adding crystalline polyolefin resin.
(2) A method of mixing ethylene vinyl acetate copolymer with crystalline polyolefine previously, and subsequently adding metalhydroxide.
(3) A method of mixing all in the lump.

Further, it is the best way to add silanol condensation catalyst at the end. Additionally, it is possible to add compounding ingredient such as antioxidant and coloring agent at any time.

The above-mentioned non-halogen flame-resistant thermoplastic elastomer composition can be applied to an electric wire or cable as an insulator or a sheath. Especially, it is possible to use for a power supply code or cabtire cable, etc. which excellent elastic behavior is hoped.

### Embodiments

Embodiments of the present invention will be concretely explained hereinafter.

The material was made according to a process where silicon analogues are graft-copolymerized to ethylene vinyl acetate copolymer, and a process where compounding ingredients such as ethylene vinyl acetate copolymers in which silicon analogues are graft-copolymerized, crystalline polyolefin resins, metalhydroxides, and silanol condensation catalysts are mixed to cross-link ethylene vinyl acetate copolymer by silane.

In the process where silicon analogues are graft-copolymerized to ethylene vinyl acetate copolymer, raw materials where ethylene vinyl acetate copolymers (the content of vinyl acetate is 25, 30, and 42 wt %), vinyl trimethoxysilanes, and dicumylperoxides are impregnated and mixed at the ratio of 100/3/0.01 parts by weight or 100/5/0.02 parts by weight are prepared. These were extruded so that retention time may become about five minutes by using 40 mm extruder at 200° C. (L/D ratio=24), and the graft reaction was made.

Next, the mixture was made by providing each blending component of each sample shown in Table 1 of FIG. 3 to a 37 mm twin screw extruder (L/D ratio=60) in the lump, and cross-linking ethylene vinyl acetate copolymer in which silicon analogues has been graft-polymerized while mixing.

The temperature was assumed to be 180° C., and screw speed was assumed to be 150 rpm. This was made a pellet, which is the material for the cable making.

The cable was coated by extruding at 1.5 mm in thickness by using 40 mm extruder (L/D=24) preheated at 180° C. A cable core was made by intertwining three wires each of which is 2 mm in outside diameter and coated with polyethylene 0.8 mm thick together with inclusion, and providing the suppression rolling to them with craft tape.

The cable made according to the above-mentioned procedure was evaluated as follows.

The durometer hardness (type A) based on JIS K 6253 was measured as an index of elastic behavior of the material. The elastic behavior of the cable was evaluated by the deflection (the distance dropped with respect to the horizontal) when one end of the cable 200 mm long was fixed, and the load of 10 g was applied to the other end. The larger the deflection is, the more excellent elastic behavior is. The desired value is set to hardness of polyvinyl chloride sheath in the vinyl cabtire cable of this shape and a deflection amount of the cable (Hardness: 90 or less; deflection 35 mm or more).

Mechanical strength, heat resistance, oil resistance, and flame resistance were evaluated in accordance with JIS C 3005. Tensile strength 10 MPa or more and breaking elongation 350% or more are accepted. Heat resistance was evaluated by heating transformation examination (75° C. and load 10N), and the thickness decrease rate 10% or less was accepted. As for the oil resistance, IRM 902 oil was made examination oil. The material was soaked for 4 hours at 70° C., and one whose percentage of retention of tensile strength is 60% or more was accepted.

As the flame resistance evaluation, 60° inclination combustion test is carried out. The flame propagation time after the flame is removed was measured, and what had been naturally extinguished within 60 seconds was accepted.

Moreover, to confirm the presence of the silane crosslink, the material has been extracted in the heat xylene at 130° C. for 24 hours. It was judged that crosslink is introduced if there is remaining insoluble polymer. The formability was judged from externals at the time of extrusion molding. After having dyed the thin film cut of the material, morphology was observed by a transmission electron microscope.

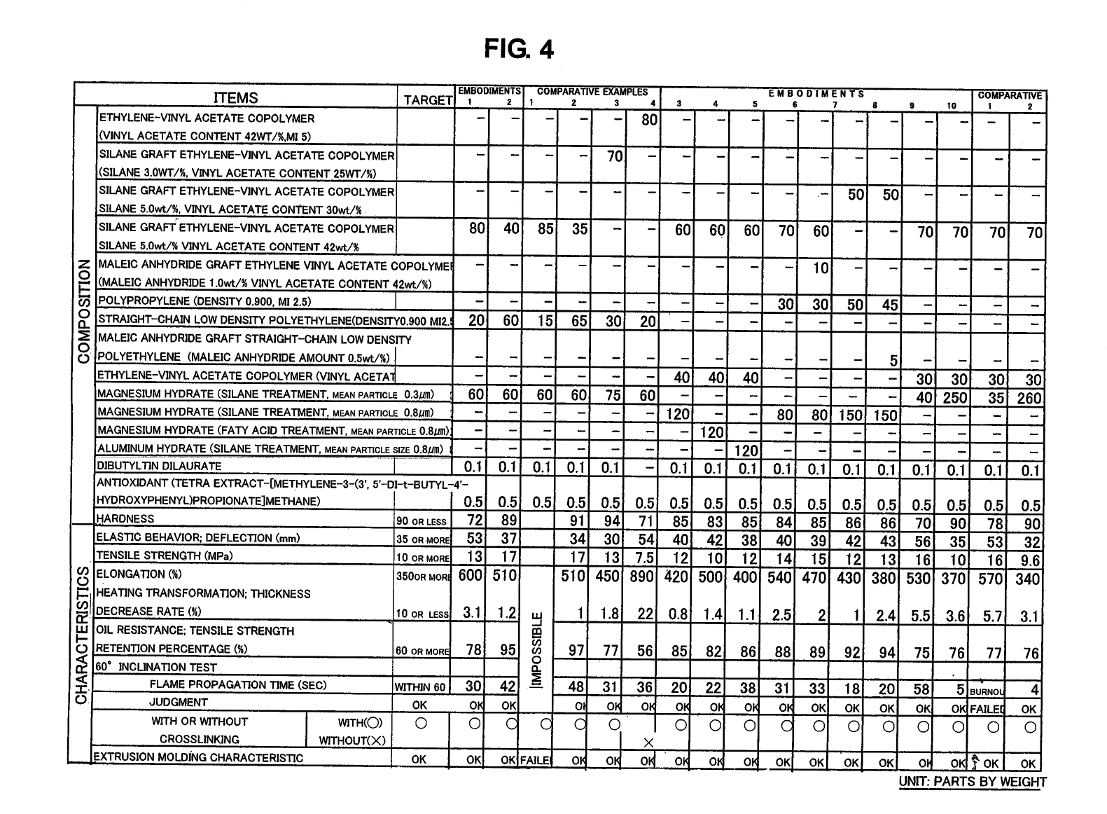

Now, referring to FIG. 4, FIG. 4 is a table showing characteristics of embodiments of the present invention and comparative examples.

In embodiments 1 to 11 of the present invention, the same elastic behavior as polyvinyl chloride is obtained as shown in Table 1 of FIG. 4, and it is excellent in the mechanical strength, heat resistance, oil resistance, flame resistance, and the formability.

Moreover, the morphology where the phase of ethylene vinyl acetate copolymer is dispersed into the phase of crystalline polyolefin resin was confirmed in embodiments 1 to 11.

The following facts are found by comparing embodiments 3 to 5. Higher tensile strength can be given by using metalhydroxide treated with silane coupling agent, and higher flame resistance can be given by using magnesium hydroxide as metalhydroxide.

It is appreciated that tensile strength of the composition have improved by the graft-polymerization of maleic anhydride which is unsaturated carboxylic acid from the comparison of embodiments 6 and 7, and the comparison of embodiments 8 and 9.

On the other hand, in comparison example 1 in which the ratio of ethylene vinyl acetate copolymer is more than a specified value of the present invention, the morphology organization which disperses crystalline polyolefin resin to ethylene vinyl acetate copolymer cross-linked is shown. Further, because the appearance of extruded product was uneven, its characteristic was not able to be measured. In comparison example 2 in which the ratio of the ethylene vinyl acetate copolymer is fewer than a specified value and comparison example 3 which uses ethylene vinyl acetate copolymer whose vinyl acetate contents are fewer than the specified value, enough elastic behavior is not obtained. In comparison example 4 where ethylene vinyl acetate copolymer is not cross-linked with silane, tensile strength was small and heating transformation and oil resistance were not able to satisfy the desired value. In comparison example 5 where an additional amount of metalhydroxide is below a regulated amount, flame resistance did not suffice, and elastic behavior were insufficient. In comparison example 6 where an additional amount of metalhydroxide is more than a specified amount, tensile strength were insufficient.

Non-halogen flame-resistant thermoplastic elastomer composition and the electric wire or cable which uses the same show excellent elastic behavior and flame resistance. In addition, they have high mechanical strength, heat resistance, and oil resistance. Accordingly, it is thought that the industrial utility of the present invention is extremely high.

Although the present invention has been illustrated and described with respect to exemplary embodiments thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments, which can be embodied within a scope encompassed and equivalent thereof with respect to the feature set out in the appended claims.

1. Non-halogen flame-resistant thermoplastic elastomer composition comprising:
(A) 40 to 80 parts by weight of ethylene-vinyl acetate copolymer, in which the content of vinyl acetate is 30 wt % or more;
(B) 60 to 20 parts by weight of crystalline polyolefin resin; and
(C) 40 to 250 parts by weight of metalhydroxide for 100 parts by weight in total of said (A) and (B);
wherein said ethylene-vinyl acetate copolymer is cross-linked with silane.

2. The non-halogen flame-resistant thermoplastic elastomer composition according to claim 1, wherein the phase of said ethylene vinyl acetate copolymer defined as said (A) is dispersed in the phase of crystalline polyolefin resin defined as said (B).

3. The non-halogen flame-resistant thermoplastic elastomer composition according to claim 1, wherein said crystalline polyolefin resin defined as said (B) is at least one selected from polypropylene, high density polyethylene, linear low density polyethylene, very low density polyethylene, ethylene-butene-1 copolymer, ethylene-hexene-1 copolymer, ethylene-octene-1 copolymer, ethylene vinyl acetate copolymer, ethylene-ethylacrylate copolymer.

4. The non-halogen flame-resistant thermoplastic elastomer composition according to claim 1, wherein metalhydroxide defined as said (C) is magnesium hydroxide, whose surface is treated with the silane based coupling agent.

5. The non-halogen flame-resistant thermoplastic elastomer composition according to claim 1, wherein unsaturated carboxylic acid or derivative thereof is copolymerized to a part of vinyl acetate defined as said (A) or a part of crystalline polyolefin resin defined as said (B).

6. A method of manufacturing non-halogen flame-resistant thermoplastic elastomer composition of claim 1, wherein said ethylene vinyl acetate copolymer cross-linked with silane is created by mixing ethylene vinyl acetate copolymer in which silicon analogues are polymerized by grafting, metalhydroxide and silanol condensation catalyst.

7. The manufacturing method according to claim 6, wherein after graft-copolimerizing silicon analogues to ethylene vinyl acetate copolymer, metalhydroxide and crystalline polyolefin based resin are added.

8. An electric wire or cable in which non-halogen flame-resistant thermoplastic elastomer composition of claim 1 is used for an insulator or a sheath.
